(19) United States
(12) Patent Application Publication
(10) Pub. No.: US 2010/0215011 A1
(43) Pub. Date: Aug. 26, 2010

(54) METHOD AND APPARATUS FOR SWITCHING A RESOURCE ASSIGNMENT MODE FOR A PLURALITY OF COMPONENT CARRIERS

(75) Inventors: Kyle Jung-Lin Pan, Smithtown, NY (US); Jean-Louis Gauvreau, La Prairie (CA); Paul Marinier, Brossard (CA); Guodong Zhang, Syosset, NY (US); Sung-Hyuk Shin, Northvale, NJ (US); Marian Rudolf, Montreal (CA); Philip J. Pietraski, Huntington Station, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/712,070

(22) Filed: Feb. 24, 2010

Related U.S. Application Data
(60) Provisional application No. 61/155,811, filed on Feb. 26, 2009.
(60) Provisional application No. 61/218,306, filed on Jun. 18, 2009.

(51) Int. Cl. H04W 72/04

(52) U.S. Cl. 370/329

(57) ABSTRACT

Techniques for configuring and switching a resource assignment mode for a plurality of component carriers are disclosed. A wireless transmit/receive unit (WTRU) has a capability of supporting multiple resource assignment modes such that a resource assignment mode is configured for a plurality of component carriers that are allocated for the WTRU, and the WTRU attempts to decode a control channel based on the configured resource assignment mode. The resource assignment mode may be configured for the WTRU via higher layer signaling. The resource assignment mode may be specific to the WTRU, or specific to a component carrier or a group of component carriers. The resource assignment mode may be configured separately for a downlink component carrier and an uplink component carrier. The resource assignment mode includes a separate assignment mode with component carrier indication, a separate assignment mode without component carrier indication, or a joint assignment mode.

### CROSS REFERENCE TO RELATED APPLICATIONS

This application claims the benefit of U.S. provisional application Nos. 61/155,811 filed Feb. 26, 2009 and 61/218,306 filed Jun. 18, 2009, which are incorporated by reference as if fully set forth.

### FIELD OF INVENTION

This application is related to wireless communications.

### BACKGROUND

In order to support higher data rate and spectrum efficiency, new wireless communication technologies have been introduced. For example, the third generation partnership project (3GPP) long term evolution (LTE) system has been introduced into 3GPP Release 8 (R8). The LTE downlink (DL) transmission is based on orthogonal frequency division multiple access (OFDMA) and the LTE uplink (UL) transmission is based on discrete Fourier transform (DFT)-spread OFDMA (DFT-S-OFDMA). The use of single-carrier transmission in the UL is motivated by the lower peak-to-average power ratio (PAPR) (or cubic metric) compared to multi-carrier transmissions such as orthogonal frequency division multiplexing (OFDM).

For the purpose of flexible deployment, the 3GPP R8 LTE systems support scalable transmission bandwidths of 1.4, 2.5, 5, 10, 15 or 20 MHz. The R8 LTE system may operate in frequency division duplex (FDD), time division duplex (TDD), or half-duplex FDD modes.

In the R8 LTE system, each radio frame (10 ms) consists of ten (10) equally sized sub-frames of 1 ms. Each sub-frame consists of two (2) equally sized timeslots of 0.5 ms. There may be either seven (7) or six (6) OFDM symbols per timeslot. Seven OFDM symbols per timeslot are used with a normal cyclic prefix length, and six OFDM symbols per timeslot are used with an extended cyclic prefix length. The sub-carrier spacing for the R8 LTE system is 15 kHz. An alternative reduced sub-carrier spacing mode using 7.5 kHz is also possible. A resource element (RE) corresponds to one (1) sub-carrier during one (1) OFDM symbol interval. 12 consecutive sub-carriers during a 0.5 ms timeslot constitute one (1) resource block (RB). Therefore, with 7 OFDM symbols per timeslot, each RB consists of 12×7=84 REs. A DL carrier may consist of scalable number of RBs, ranging from a minimum of 6 RBs up to a maximum of 110 RBs. This corresponds to an overall scalable transmission bandwidth of roughly 1 MHz up to 20 MHz. Normally, a set of common transmission bandwidths is specified, e.g., 1.4, 3, 5, 10, or 20 MHz. The basic time-domain unit for dynamic scheduling in LTE is one sub-frame consisting of two consecutive timeslots. Certain sub-carriers on some OFDM symbols are allocated to carry pilot signals in the time-frequency grid.

In the R8 LTE DL direction, a wireless transmit/receive unit (WTRU) may be allocated by the evolved Node-B (eNode-B) to receive its data anywhere across the whole LTE transmission bandwidth. In the R8 LTE UL direction, a WTRU may transmit on a limited, yet contiguous set of assigned sub-carriers in an FDMA arrangement. This is called single carrier (SC) FDMA. For example, if the overall OFDM signal or system bandwidth in the UL is composed of sub-carriers numbered 1 to 100, a first WTRU may be assigned to transmit its own signal on sub-carriers 1-12, a second WTRU may transmit on sub-carriers 13-24, and so on. An eNode-B would receive the composite UL signals across the entire transmission bandwidth normally from a plurality of WTRUs at the same time, but each WTRU would transmit in a subset of the available transmission bandwidth. Frequency hopping may be applied in UL transmissions by a WTRU.

In order to further improve achievable throughput and coverage of LTE-based radio access systems, and in order to meet the IMT-Advanced requirements of 1 Gbps and 500 Mbps in the DL and UL directions, respectively, LTE-Advanced (LTE-A) is currently under study in 3GPP standardization body.

One major improvement proposed for LTE-A is the carrier aggregation and support of flexible bandwidth arrangement. It would allow DL and UL transmission bandwidths to exceed 20 MHz in R8 LTE, (e.g., 40 MHz), and allow for more flexible usage of the available paired carriers. For example, whereas R8 LTE is limited to operate in symmetrical and paired FDD mode, (e.g., DL and UL are both 10 MHz or 20 MHz transmission bandwidth each), LTE-A would be able to operate in asymmetric configurations, for example DL 10 MHz paired with UL 5 MHz. In addition, composite aggregate transmission bandwidths may be possible with LTE-A, (e.g., DL a first 20 MHz carrier+a second 10 MHz carrier paired with an UL 20 MHz carrier). The composite aggregate transmission bandwidths may not necessarily be contiguous in frequency domain. Alternatively, operation in contiguous aggregate transmission bandwidths may also be possible, (e.g., a first DL component carrier of 15 MHz is aggregated with another 15 MHz DL component carrier and paired with a UL carrier of 20 MHz).

In the R8 LTE system DL direction, WTRUs transmit their data (and in some cases their control information) on a physical downlink shared channel (PDSCH). The transmission of the PDSCH is scheduled and controlled by the eNode-B using the downlink scheduling assignment, which is carried on a physical downlink control channel (PDCCH). As part of the downlink scheduling assignment, the WTRU receives control information on the modulation and coding scheme (MCS), downlink resources allocation (i.e., the indices of allocated resource blocks), etc. If a scheduling assignment for the WTRU is received, the WTRU decodes its allocated PDSCH on the allocated downlink resources.

In LTE_A, PDSCH(s) to a given WTRU may be transmitted on more than one assigned component carriers. In LTE-A using the carrier aggregation mechanism, different approaches for allocating PDSCH resources on more than one component carrier have been proposed.

In accordance with one proposed mode of operation in an LTE-A system, the PDCCHs or downlink control information (DCI) messages contained therein carrying the resource assignment information are separately transmitted for the component carriers containing the accompanying PDSCH transmissions. For example, if there are two (2) component carriers, two separate DCI messages are transmitted on each component carrier corresponding to the PDSCH transmissions, respectively. Alternatively, the two separate DCI messages for the WTRU may be sent on one component carrier, even though they may pertain to accompanying data or PDSCH transmissions on different component carriers. Hereafter, this mode of operation is referred to as “separate PDCCH mode.” The separate DCI messages of PDCCHs for a WTRU or a group of WTRUs may be transmitted in one or multiple carriers, and not necessarily all of them on every component carrier.

In another mode of operation, the DCI messages carrying the resource assignment information for PDSCH(s) on more than one component carrier may be encoded jointly and carried by a single joint DCI message, or PDCCH message. For example, a single DCI or PDCCH or control message carrying a resource assignment for PDSCHs on two or more component carriers may be sent to the WTRU. Hereafter, this mode of operation is referred to as “joint PDCCH mode.” For example, the joint PDCCH for a WTRU or group of WTRUs may be transmitted in one or multiple carriers.

The above operations explained in terms of DL control messages (or DCI or PDCCH) and assignment messages and the DL resource allocations also apply to UL assignment messages and UL resource allocations. This is because the PDCCH or control region of a subframe in an LTE system carries both DL assignment messages (DAM) and UL assignment messages (UAM). Similar to the allocation modes for the DL, UAMs may pertain to an allocation on multiple UL component carriers, or an individual UAM may pertain to an UL allocation on a single UL component carrier.

In an LTE-A system using carrier aggregation, different PDCCH modes have different advantages and disadvantages. For example, the separate PDCCH mode provides much flexibility in terms of possible resource assignments. Moreover, for considerations related to the payload of separately encoded downlink or uplink assignment messages with respect to addressable RBs, bandwidth and flexibility of mapping into the control region resource elements, the separate PDCCH mode is naturally backward-compatible with R8 LTE legacy equipment. However, the separate PDCCH mode results in higher overhead and higher blind detection complexity when compared to the joint PDCCH mode, particularly as the number of component carriers increases.

The joint PDCCH mode may result in restrictions regarding allocation flexibility due to the same considerations with respect to payload and mapping into the control region. However, the joint PDCCH mode may result in less overhead and lower WTRU blind detection complexity. This may be important for power consumption considerations, because the joint PDCCH mode may allow the WTRU to monitor one component carrier at a time. However, the joint PDCCH mode may suffer from excessive overhead when the number of component carriers used for a specific transmission is low.

In addition, practical restrictions with respect to the possible use of the individual PDCCH modes exist. For example, in an LTE-A system using multiple uplink carriers with one configured downlink component carrier, any UAM messages may be contained on the single DL component carrier. In yet another example, if a WTRU is required to monitor and process individual DAM and/or UAM on the individual component carriers, this becomes quickly prohibitive for WTRU power consumption when more than two aggregated component carriers are used.

Therefore, in order to reduce WTRU power consumption and operational complexity during LTE-A operation in a variety of scenarios, it would be desirable to provide methods that allow assignment of DL and UL resources in a flexible manner.

### SUMMARY

Techniques for switching a resource assignment mode for a plurality of component carriers are disclosed. A WTRU is configured to transmit and/or receive via multiple component carriers. The WTRU receives resource assignment from the network for transmission and reception via the component carriers. The WTRU may receive higher layer signaling, such as radio resource control (RRC) signaling, including an information element for resource assignment mode switching among a plurality of resource assignment modes for a plurality of component carriers. The WTRU then switches a resource assignment mode based on the higher layer signaling.

The resource assignment mode may be a separate assignment mode for assigning a resource for multiple component carriers with separate resource assignment messages being transmitted on the same component carrier on which the corresponding data is scheduled, or a separate assignment mode for assigning a resource for multiple component carriers with separate resource assignment messages that may be transmitted on a different component carrier on which the corresponding data is scheduled. The resource assignment mode may be a joint assignment mode for assigning a resource for multiple component carriers with a single extended resource assignment message. The information element may indicate a specific component carrier, a specific subset of component carriers, a specific group of component carriers, or a specific transmission direction, (i.e., downlink or uplink), to which the resource assignment switching is applied. The higher layer signaling may include a plurality of information elements for a set of component carriers to trigger the resource assignment mode switching on a component carrier, component carrier group, or transmission direction basis. The resource assignment mode switching may occur in a specific resource assignment mode switching opportunity.

The resource assignment mode switching may be based on the interference conditions or number of active component carriers in a subset of component carriers. The separate assignment mode may be used on a condition that interference levels from other cells or sites for some component carriers exceed a predetermined threshold.

In addition, if a joint assignment mode is used in addition to separate assignment modes, the separate assignment mode may be used on a condition that the number of active component carriers is lower than a predetermined threshold. The joint assignment mode may be used on a condition that the number of active component carriers is greater than or equal to the threshold. The WTRU may attempt to decode a control channel on a higher priority component carrier first within a set of active component carriers. A DCI format against which the WTRU attempts to decode for a control channel may be determined based on the number of active component carriers in the set of component carriers.

### BRIEF DESCRIPTION OF THE DRAWINGS

A more detailed understanding may be had from the following description, given by way of example in conjunction with the accompanying drawings wherein:

FIG. 1 shows an LTE wireless communication system/access network that includes an Evolved-Universal Terrestrial Radio Access Network (E-UTRAN);

FIG. 2 is an example block diagram of an LTE wireless communication system including the WTRU, the eNode-B, and the MME/S-GW;

FIG. 3 is a flow diagram of an example process of resource assignment mode configuration or switching in accordance with one embodiment;

FIG. 4 shows an example of resource assignment modes for a plurality of component carriers;

FIG. 5 is a flow diagram of a process for PDCCH mode switching in accordance with the first embodiment;

FIG. 6 is a flow diagram of a process for PDCCH mode switching in accordance with the second embodiment;

FIG. 7 is a flow diagram of a process of PDCCH mode switching in accordance with the fourth embodiment;

FIG. 8 is a flow diagram of a process for PDCCH mode switching in accordance with the fifth embodiment;

FIG. 9 is a flow diagram of a process for PDCCH mode switching in accordance with the eighth embodiment;

FIG. 10 shows an example MAC PDU comprising a MAC header, MAC control elements, MAC service data units (SDUs), and padding;

FIG. 11 is a flow diagram of a process of PDCCH mode switching in accordance with tenth embodiment;

FIG. 12 is a flow diagram of a process of PDCCH mode switching in accordance with the twelfth embodiment; and

FIG. 13 is a flow diagram of a process for PDCCH mode switching in accordance with the seventeenth embodiments.

### DETAILED DESCRIPTION

When referred to hereafter, the terminology “WTRU” includes but is not limited to a user equipment (UE), a mobile station, a fixed or mobile subscriber unit, a pager, a cellular telephone, a personal digital assistant (PDA), a computer, a machine-to-machine device, a sensor, or any other type of device capable of operating in a wireless environment. When referred to hereafter, the terminology “eNode-B” includes but is not limited to a base station, a Node-B, a site controller, an access point (AP), or any other type of interfacing device capable of operating in a wireless environment. When referred to hereafter, the terminologies “PDCCH mode” and the “resource assignment mode” will be used interchangeably.

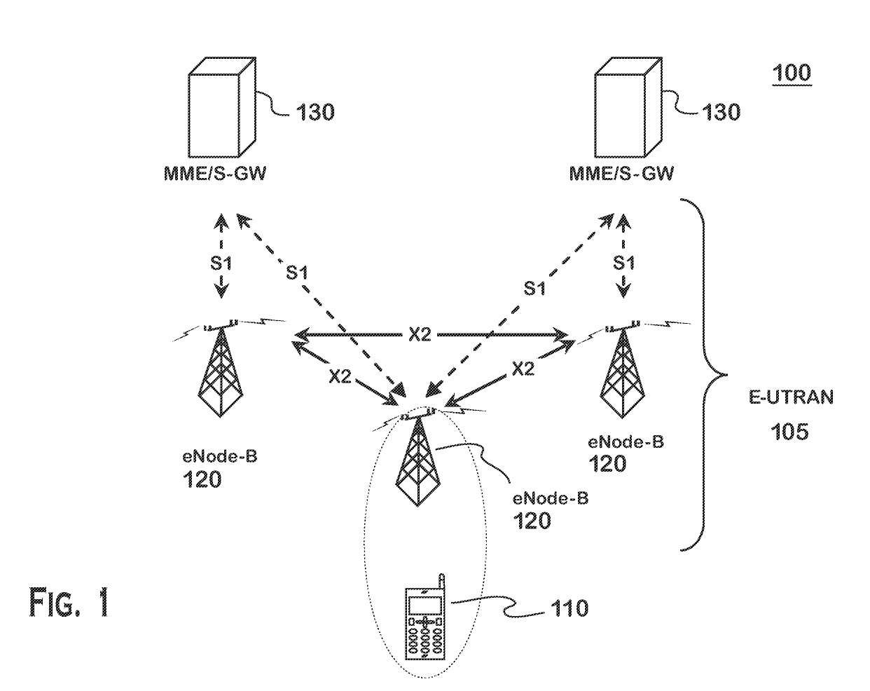

FIG. 1 shows an LTE wireless communication system/access network 100 that includes an Evolved-Universal Terrestrial Radio Access Network (E-UTRAN) 105. The E-UTRAN 105 includes several eNode-Bs 120. The WTRU 110 is in communication with an eNode-B 120. The eNode-Bs 120 interface with each other using an X2 interface. Each of the eNode-Bs 120 interface with a Mobility Management Entity (MME)/Serving GateWay (S-GW) 130 through an S1 interface. Although a single WTRU 110 and three eNode-Bs 120 are shown in FIG. 1, it should be noted that any combination of wireless and wired devices may be included in the wireless communication system access network 100.

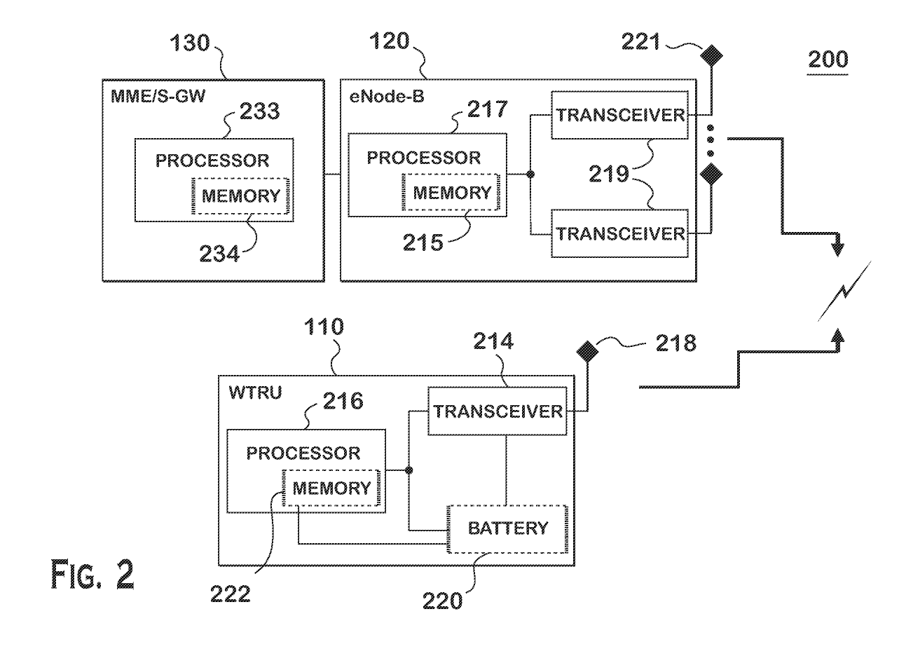

FIG. 2 is an example block diagram of an LTE wireless communication system 200 including the WTRU 110, the eNode-B 120, and the MME/S-GW 130. As shown in FIG. 2, the WTRU 110, the eNode-B 120 and the MME/S-GW 130 are configured to perform a method for switching a resource assignment mode for a plurality of component carriers.

In addition to the components that may be found in a typical WTRU, the WTRU 110 includes a processor 216 with an optional linked memory 222, at least one transceiver 214, an optional battery 220, and an antenna 218. The processor 216 is configured to perform, either alone or in association with software, a method for switching a resource assignment mode for a plurality of component carriers. The transceiver 214 is in communication with the processor 216 and the antenna 218 to facilitate the transmission and reception of wireless communications. In case a battery 220 is used in the WTRU 110, it powers the transceiver 214 and the processor 216.

In addition to the components that may be found in a typical eNode-B, the eNode-B 120 includes a processor 217 with an optional linked memory 215, transceivers 219, and antennas 221. The processor 217 is configured to perform, either alone or in association with software, a method for switching a resource assignment mode for a plurality of component carriers. The transceivers 219 are in communication with the processor 217 and antennas 221 to facilitate the transmission and reception of wireless communications. The eNode-B 120 is connected to the Mobility Management Entity/Serving GateWay (MME/S-GW) 130 which includes a processor 233 with an optional linked memory 234.

Embodiments for a WTRU and a system operating with two or more resource assignment modes are disclosed. Embodiments for a WTRU and a system supporting resource assignment mode which is specific to the WTRU instead of a cell or system are also disclosed. Embodiments for a WTRU and a system enabling resource assignment mode which is specific to a component carrier or a component carrier group of the same WTRU are also disclosed. Embodiments for a WTRU and a system enabling resource assignment mode separately for DL and UL are also disclosed. Embodiments for a WTRU and a system switching or configuring a resource assignment mode, (i.e., PDCCH mode), for the above embodiments accordingly are also disclosed.

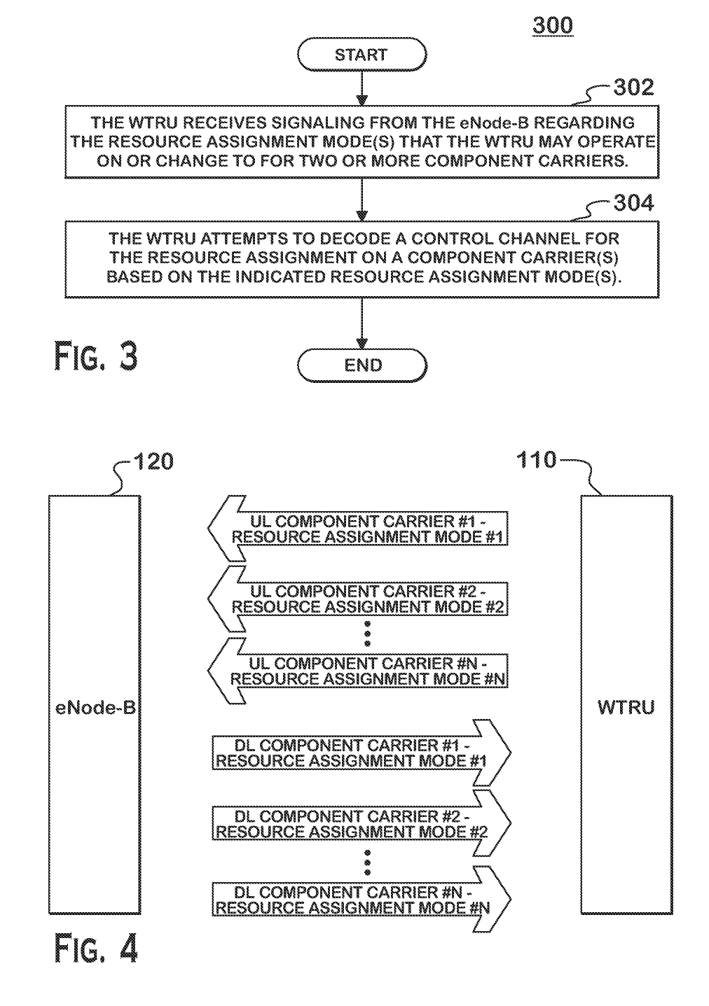

FIG. 3 is a flow diagram of an example process 300 of resource assignment mode configuration or switching in accordance with one embodiment. A WTRU and an eNode-B may support two or more resource assignment modes. The WTRU may receive signaling (signaling or message in any layers) from the eNode-B regarding the resource assignment mode(s) that the WTRU may operate on, or change to, for two or more component carriers (DL component carriers, UL component carriers, or both) (step 302). The signaling may indicate how the resource assignment mode(s) needs to be applied to the component carriers. The WTRU then attempts to decode a control channel for the resource assignment (either for DL or UL, or both) on a component carrier(s) based on the indicated resource assignment mode(s) (step 304).

The resource assignment modes include a separate assignment mode with carrier indication and a separate assignment mode without carrier indication. The resource assignment modes may also include a joint assignment mode. In the separate assignment mode without carrier indication, the control messages, (e.g., a PDCCH), for multiple component carriers are separately coded into separate messages and separately transmitted via each corresponding component carrier. In the separate assignment mode with carrier indication, the control messages, (e.g., a PDCCH), are separately coded into separate messages and may be jointly transmitted via one (or a few) DL component carrier. In the separate resource assignment mode with carrier indication, the downlink control message, (e.g., a PDCCH), may be transmitted in a different DL carrier on which the data, (e.g., PDSCH and/or associated PUSCH), is transmitted along with a component carrier indication. In the joint assignment mode, the control messages, (e.g., a PDCCH), are jointly coded into one message and transmitted via one (or a few) DL component carrier. PDCCHs may be transmitted in one DL carrier (e.g., anchor carrier) or a subset of DL carriers. A PDCCH may include DL or UL grants.

The resource assignment mode may be specific to the WTRU, instead of cell or system. In this case, each WTRU may operate with a different resource assignment mode(s).

Alternatively or additionally, the resource assignment mode may be specific to each component carrier or a group of component carriers. The WTRU may receive the signaling from the eNode-B indicating that the resource assignment mode is common, partially common, or specific to the component carriers.

If the WTRU receives signaling from the eNode-B indicating that the resource assignment mode is common to the component carriers, the indicated resource assignment mode may be applied to all component carriers and the WTRU may operate on the same resource assignment mode for all component carriers.

If the WTRU receives signaling indicating that the resource assignment mode is specific to a particular component carrier(s), the indicated resource assignment mode may be applied to that particular component carrier(s). The WTRU may decode the control channel in each component carrier using the resource assignment mode that is indicated for that particular component carrier. The WTRU may operate with different resource assignment modes on different component carriers according to the signaling received from the eNode-B. FIG. 4 shows an example of resource assignment modes for a plurality of component carriers. N DL and UL component carriers are respectively assigned for the WTRU and each component carrier is assigned with a corresponding resource assignment mode, wherein N may be one (1) or more than one (1).

The resource assignment mode(s) for the component carriers may be configured specifically for each, or a group, of the component carrier(s), (i.e., each, or a group, of the component carriers may be configured in a different resource assignment mode). For example, the WTRU may operate on some component carrier(s) (one or more UL and/or DL component carriers) using one resource assignment mode, (e.g., a separate assignment mode without component carrier indication), and operate on other component carrier(s) (one or more UL and/or DL component carriers) using another resource assignment mode, (e.g., a separate assignment mode with component carrier indication).

The WTRU may limit cross-carrier scheduling within the group of component carriers (CC). With cross-carrier scheduling, resource assignment transmitted in one component carrier may schedule data transmission in another component carrier. For example, the WTRU may operate on two groups of component carrier(s) (e.g., a first group of CC1 and CC2, and a second group of CC3 and CC4) using the same resource assignment mode for both groups, (e.g., a separate assignment mode with component carrier indication) with a limitation of component carrier indication within the corresponding component carrier group. The cross-carrier scheduling may be performed within each component carrier group. In this case, the WTRU may operate with cross-carrier scheduling for CC1 and CC2 and with another independent and separate cross-carrier scheduling for CC3 and CC4. Component carrier indication may be used within CC1 and CC2, (i.e., CC1 or CC2 may be scheduled by one of CC1 and CC2 or both, but not by CC3 and CC4), and within CC3 and CC4, (i.e., CC3 or CC4 may be scheduled by one of CC3 and CC4 or both, but not by CC1 and CC2). Information about which CC may be used to schedule other CC or CCs may be indicated by the eNode-B.

If the WTRU receives signaling indicating that the resource assignment mode is partially common to a group, or groups, of component carriers, the WTRU may decode the control channel in the component carriers belonging to the indicated component carrier group using the resource assignment mode that is indicated for that component carrier group. The WTRU may operate on the component carrier group using any resource assignment mode, (e.g., a separate assignment mode with or without component carrier indication). Cross carrier scheduling may be performed within the component carrier group(s), (i.e., the WTRU may be scheduled for component carriers in the same component carrier group but not outside the component carrier group or across different component carrier groups. This may help reduce WTRU blind decoding complexity for resource assignment decoding.

Alternatively and additionally, the resource assignment mode may be specific to UL component carrier(s) or DL component carrier(s). The WTRU may receive signaling indicating that the resource assignment mode is specific to DL or UL component carriers. In this case, the WTRU may operate on two or more different resource assignment modes on the DL and UL component carriers according to the signaling received from the eNode-B. For example, the WTRU may operate on a DL component carrier(s) using one or more resource assignment mode(s) and on a UL component carrier(s) using another resource assignment mode(s). The WTRU may decode the control channel for DL assignment using the resource assignment mode(s) that is indicated for the DL component carrier(s) and decode the control channel for the UL grant using the resource assignment mode(s) that is indicated for the UL component carrier(s).

It should be noted that although embodiments below are disclosed with reference to switching between two different separate PDCCH modes, (e.g., between a separate PDCCH mode with component carrier indication and a separate PDCCH mode without component carrier indication), the embodiments are equally applicable to switching between any other types of PDCCH modes and among more than two PDCCH modes. Even though embodiments are mainly described with reference to downlink carriers, it should be understood that the embodiments described herein are applicable to uplink carriers as well.

Different PDCCH modes may be provided between DAM and UAM and the embodiments described herein may be applied for DAM and/or UAM. The PDCCH modes may be configured separately for DAM and UAM or PDCCH mode switching may be indicated separately for DAM and UAM. For example, a PDCCH may contain DAMs using a separate assignment mode (e.g., a separate PDCCH mode with component carrier indication or a separate PDCCH mode without component carrier indication), while the UAM may use a different separate assignment mode or a joint assignment mode, and the PDCCH mode switching may be indicated separately. Other combinations are equally possible and suitable for system operation.

In addition, different PDCCH modes may be provided between DCIs or DCI formats and the embodiments described herein may be applied for different DCIs or DCI formats. The PDCCH modes may be configured separately for different DCIs or DCI formats, or PDCCH mode switching may be indicated separately for different DCIs or DCI formats. The WTRU may operate on DCIs or DCI formats using different resource assignment modes. The WTRU may receive signaling from the eNode-B and is indicated to decode some DCIs or DCI formats using one resource assignment mode and decode other DCIs or DCI formats using another resource assignment mode. Some DCIs or DCI formats may be associated with a fixed resource assignment mode and the WTRU may decode those DCIs using the fixed resource assignment mode. The WTRU may receive signaling from the eNode-B indicating to decode other DCIs or DCI formats using the resource assignment mode that is indicated or switched to.

The embodiments explained in terms of an assignment message addressed to an individual WTRU are equally applicable to the cases where groups of WTRUs are the intended receivers of the resource allocations. For example, a DCI pertaining to a PDSCH containing system information may be intended for reception by more than one WTRU.

Even though the embodiments are disclosed with reference to control channels and data channels associated to 3GPP LTE, it should be noted that the embodiments are applicable to any wireless communication technologies that are currently existing or will be developed in the future including, but not limited to, 3GPP high speed packet access (HSPA), LTE-A, cdma2000, IEEE 802.xx, etc. It should also be noted that the embodiments described herein may be applicable in any order or combinations.

In accordance with one embodiment, the PDCCH mode switching may be implicitly indicated through the use of a special WTRU identity, (e.g., a special cell radio network temporary identity (C-RNTI)). DCI is carried in the PDCCH. The cyclic redundancy check (CRC) parity bits of the DCI are scrambled with the C-RNTI, (i.e., non-special C-RNTI), assigned to the WTRU to identify the WTRU in a cell. In accordance with the first embodiment, a WTRU may be assigned with both the C-RNTI and the special C-RNTI and the WTRU attempts to decode the PDCCH with both the C-RNTI and the special C-RNTI.

The special C-RNTI may be used for the PDCCH mode switching. If the WTRU is in a first PDCCH mode, (e.g., a separate PDCCH mode with component carrier indication, a separate PDCCH mode without component carrier indication, or a joint PDCCH mode), a PDCCH with a C-RNTI (i.e., non-special C-RNTI) is used for staying in the first PDCCH mode, and a PDCCH with a special C-RNTI is used for switching to a second PDCCH mode. On the other hand, if the WTRU is in a second PDCCH mode, a PDCCH with a special C-RNTI is used for staying in the second PDCCH mode, and a PDCCH with a C-RNTI is used for switching to the first PDCCH mode.

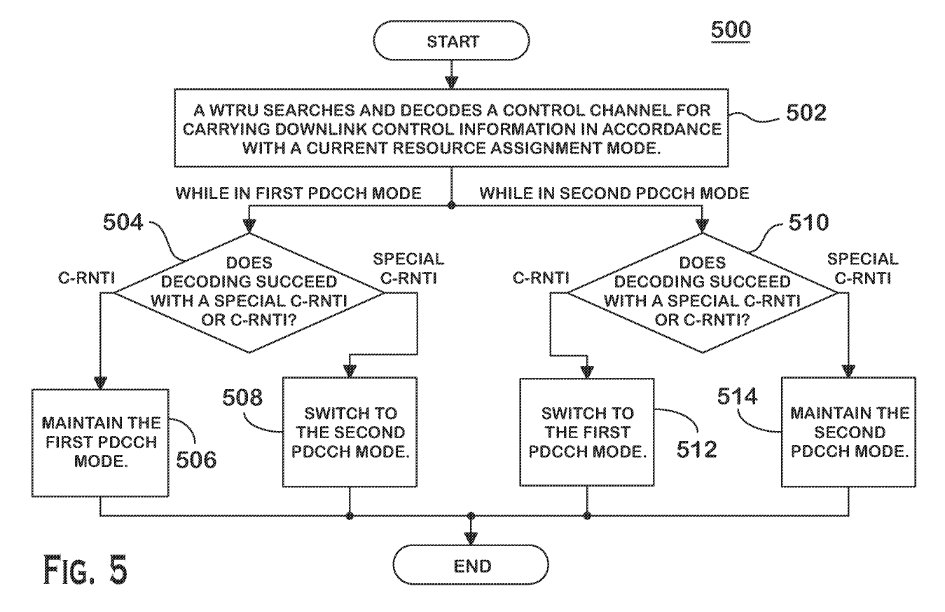

FIG. 5 is a flow diagram of a process 500 for PDCCH mode switching in accordance with the first embodiment. A WTRU searches, and decodes, a control channel carrying downlink control information in accordance with a current resource assignment mode (step 502). The current resource assignment mode, (e.g., another one of a separate PDCCH mode with component carrier indication, a separate PDCCH mode without component carrier indication, or a joint PDCCH mode), may be an initially configured mode by a higher layer (e.g., RRC signaling), a default mode, or an indicated mode. If the current mode is a separate PDCCH mode, the WTRU decodes the PDCCH in accordance with a DCI format corresponding to the separate PDCCH mode, and if the current mode is a joint PDCCH mode, the WTRU decodes the PDCCH in accordance with a DCI format corresponding to the joint PDCCH mode.

The WTRU is configured with a special C-RNTI (e.g., J-C-RNTI) along with a C-RNTI (normal C-RNTI) and performs cyclic redundancy check (CRC) with both the special C-RNTI and the normal C-RNTI. While in a first PDCCH mode, (e.g., one of a separate PDCCH mode with component carrier indication, a separate PDCCH mode without component carrier indication, or a joint PDCCH mode), if the WTRU successfully decodes the PDCCH with the special C-RNTI (step 504), (i.e., CRC check passes with the special C-RNTI), the WTRU switches to a second PDCCH mode, (e.g., another one of a separate PDCCH mode with component carrier indication, a separate PDCCH mode without component carrier indication, or a joint PDCCH mode) (step 508), and if the WTRU successfully decodes the PDCCH with the C-RNTI (step 504), (i.e., CRC passes with the C-RNTI), the WTRU maintains the first PDCCH mode (step 506).

On the other hand, while in the second PDCCH mode, if the WTRU successfully decodes the PDCCH with the special C-RNTI (step 510), the WTRU maintains the PDCCH mode (step 514), and if the WTRU successfully decodes the PDCCH with the C-RNTI (step 510), the WTRU switches to the first PDCCH mode (step 512).

Alternatively, the special C-RNTI may be used for switching the PDCCH mode regardless of the currently configured PDCCH mode, so that if the WTRU successfully decoded the PDCCH with the special C-RNTI, the WTRU switches the PDCCH mode, and if the WTRU successfully decodes the PDCCH with the normal C-RNTI, the WTRU maintains the current PDCCH mode.

To limit the number of PDCCH blind detection, a specific component carrier may be assigned by the network so that the implicit trigger may be indicated on this component carrier. This would allow the WTRU to perform the additional CRC check for one WTRU-specific search space.

In accordance with a second embodiment, an explicit indication may be given to the WTRU to indicate the PDCCH mode switching by using a predefined “code-point” in a PDCCH.

If it is in a first PDCCH mode, (e.g., one of a separate PDCCH mode with component carrier indication, a separate PDCCH mode without component carrier indication, or a joint PDCCH mode), a PDCCH without the predefined code-point may be used for staying in the first PDCCH mode. PDCCH with the predefined code-point may be used for switching to another PDCCH mode, (e.g., another one of a separate PDCCH mode with component carrier indication, a separate PDCCH mode without component carrier indication, or a joint PDCCH mode).

A particular control field may be used to define the code-point for PDCCH mode switching. Alternatively, a combination of control fields may be used to define the code-point for PDCCH mode switching. For example, the code-point may be defined by combination of an MCS index and a new data indicator (NDI). Currently, there are reserved bit positions for the MCS index in the modulation and transport block size (TBS) index table for PDSCH and modulation and the TBS index and redundancy version table for PUSCH. For example, the code-point for PDCCH mode switching may be defined as the NDI field toggled (i.e., set to one) and MCS={29, 30, 31}.

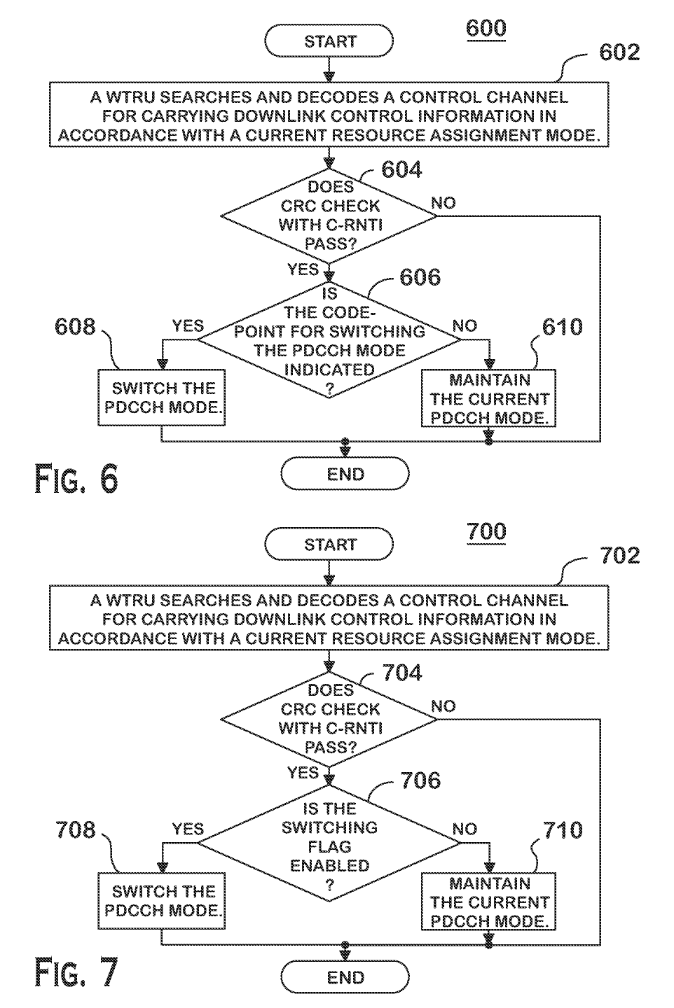

FIG. 6 is a flow diagram of a process 600 for PDCCH mode switching in accordance with the second embodiment. A WTRU searches and decodes a control channel for carrying downlink control information in accordance with a current resource assignment mode (step 602). The current resource assignment mode, (e.g., a separate PDCCH mode with component carrier indication, a separate PDCCH mode without component carrier indication, or a joint PDCCH mode), may be an initially configured mode by a higher layer (e.g., RRC signaling), a default mode, or an indicated mode.

If CRC check with C-RNTI passes (step 604), the WTRU checks whether the PDCCH switching code-point is indicated (step 606). For example, in case where one code-point defined by the combination of NDI and MCS index of 29 is used as the PDCCH switching code-point, the WTRU may check whether the NDI is toggled and the MCS index is 29. If the WTRU detects the PDCCH switching code-point (i.e., NDI toggled and MCS of 29) at step 606, the WTRU switches the PDCCH mode (step 608). For example, if the WTRU is in a first PDCCH mode, (e.g., one of a separate PDCCH mode with component carrier indication, a separate PDCCH mode without component carrier indication, or a joint PDCCH mode), the WTRU switches to the second PDCCH mode, (e.g., another one of a separate PDCCH mode with component carrier indication, a separate PDCCH mode without component carrier indication, or a joint PDCCH mode), and if the WTRU is in a second PDCCH mode, the WTRU switches to the first PDCCH. If the WTRU does not detect the code-point (NDI toggled and MCS index of 29) at step 606, the WTRU maintains the current PDCCH mode (step 610).

Alternatively, two (or more) code-points may be used for PDCCH mode switching. For example, switching code-point 1 may be defined as NDI toggled and MCS index of 29, and switching code-point 2 may be defined as NDI toggled and MCS index of 30. In this case, if switching code-point 1 is identified, the WTRU switches to the first PDCCH mode, and if switching code-point 2 is identified, the WTRU switches to the second PDCCH mode, or vice versa.

Example code-points for the PDCCH mode switching are provided in Table 1. One, some or all of them may be used as the code-point(s) for PDCCH mode.

TABLE 1

| Switching | | | |
|---|---|---|---|
| Code-Point | Code-point 1 | Code-point 2 | Code-point 3 |
| New Data | Toggled | Toggled | Toggled |
| Indicator | (alternatively | (alternatively | (alternatively |
| (NDI) | one) | one) | one) |
| MCS Index | 29 | 30 | 31 |

In accordance with a third embodiment, the combination of the special WTRU identity, such as a special C-RNTI (e.g., J-C-RNTI) and a switching code-point may be used to indicate the PDCCH mode switching between the PDCCH modes. For example, while in a first coding PDCCH mode, (e.g., one of a separate PDCCH mode with component carrier indication, a separate PDCCH mode without component carrier indication, or a joint PDCCH mode), if a PDCCH with a C-RNTI and with no PDCCH switching code-point is decoded, the first PDCCH mode is maintained, and if a PDCCH with the special C-RNTI and with the PDCCH switching code-point is decoded, the WTRU switches to the second PDCCH mode, (e.g., another one of a separate PDCCH mode with component carrier indication, a separate PDCCH mode without component carrier indication, or a joint PDCCH mode). On the other hand, while in a second PDCCH mode, if a PDCCH with special C-RNTI and with no PDCCH switching code-point is decoded, the WTRU maintains the second PDCCH mode, and if a PDCCH with a C-RNTI and with a PDCCH switching code-point is decoded, the WTRU switches to the first PDCCH mode.

In accordance with a fourth embodiment, a “switching flag” may be used to switch between the PDCCH modes. Additional control field in a DCI format may be used for the switching flag. One bit (or multiple bits) may be used as the switching flag. If the switching flag is enabled (e.g., set to one), a PDCCH mode is switched, and if the switching flag is disabled (e.g., set to zero), the current PDCCH mode is maintained.

FIG. 7 is a flow diagram of a process 700 of PDCCH mode switching in accordance with the fourth embodiment. A WTRU searches and decodes a control channel for carrying downlink control information in accordance with a current resource assignment mode (step 702). The current resource assignment mode, (e.g., a separate PDCCH mode with component carrier indication, a separate PDCCH mode without component carrier indication, or a joint PDCCH mode), may be an initially configured mode by a higher layer (e.g., RRC signaling), a default mode, or an indicated mode.

If CRC check with C-RNTI passes (step 704), the WTRU checks whether the switching flag is enabled or disabled (step 706). If the switching flag is enabled, the WTRU switches the PDCCH mode (step 708). If it was a first PDCCH mode, (e.g., one of a separate PDCCH mode with component carrier indication, a separate PDCCH mode without component carrier indication, or a joint PDCCH mode), the WTRU switches to the second PDCCH mode, (e.g., another one of a separate PDCCH mode with component carrier indication, a separate PDCCH mode without component carrier indication, or a joint PDCCH mode), and if it was a second PDCCH mode, the WTRU switches to the first PDCCH mode. If the switching flag is disabled, the WTRU maintains the current PDCCH mode (step 710). If the CRC check with the C-RNTI fails, no PDCCH transmission is indicated.

In accordance with a fifth embodiment, different DCI formats may be used to implicitly indicate the PDCCH mode switching. DCI is carried in the PDCCH and different formats of DCI are used depending on the purpose of the downlink control message. For example, DCI format 1 is used for assignment of a PDSCH resource when no spatial multiplexing is used. The CRC of the DCI is scrambled with the WTRU identity (e.g., C-RNTI) assigned to the WTRU. Different DCI formats may be defined for the resource assignment modes and the WTRU may implicitly know that which resource assignment mode is used based on the detected DCI format.

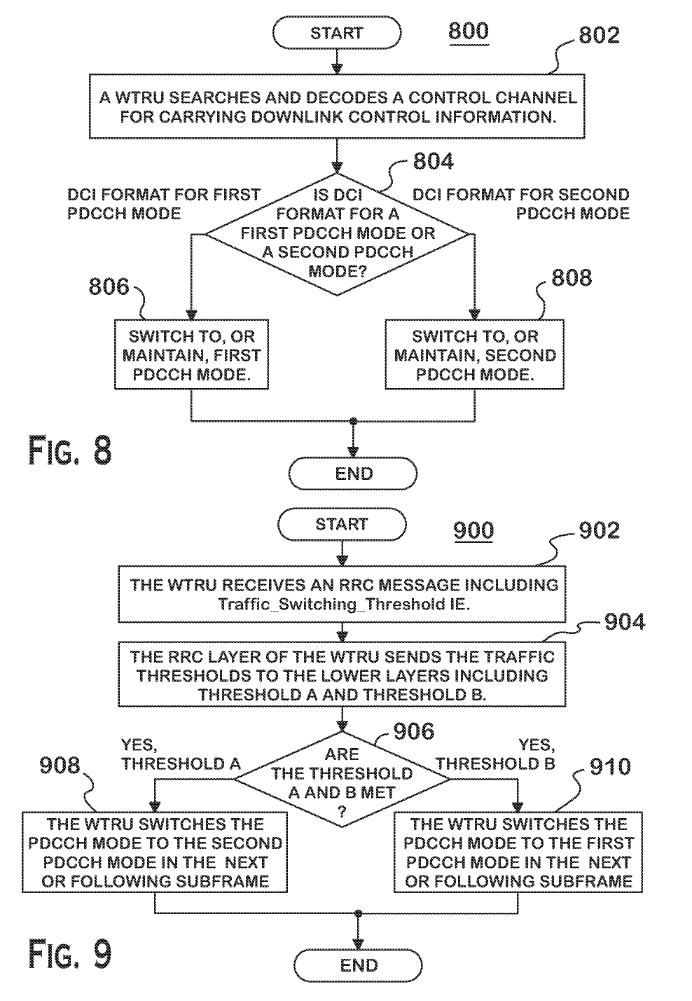

FIG. 8 is a flow diagram of a process 800 for PDCCH mode switching in accordance with the fifth embodiment. A WTRU searches and decodes a control channel for carrying downlink control information (step 802). Different DCI formats may be defined for different PDCCH modes, (e.g., a DCI format for a separate PDCCH mode with component carrier indication, a DCI format for a separate PDCCH mode without component carrier indication, and a DCI format for a joint PDCCH mode). The WTRU performs a blind detection in every subframe without knowing the currently used DCI format. If a first PDCCH mode DCI format is detected, (e.g., a DCI format for one of a separate PDCCH mode with component carrier indication, a separate PDCCH mode without component carrier indication, or a joint PDCCH mode) (step 804), a WTRU switches to a first PDCCH mode if the WTRU was in a PDCCH mode other than the first PDCCH mode, (e.g., another one of a separate PDCCH mode with component carrier indication, a separate PDCCH mode without component carrier indication, or a joint PDCCH mode), and maintains the first PDCCH mode if the WTRU was in the first PDCCH mode (step 806). If a second PDCCH mode DCI format is detected, (e.g., a DCI format for another one of a separate PDCCH mode with component carrier indication, a separate PDCCH mode without component carrier indication, or a joint PDCCH mode) (step 804), the WTRU switches to the second PDCCH mode if the WTRU was in a PDCCH mode other than the second PDCCH mode, and maintains the second PDCCH mode if the WTRU was in the second PDCCH mode (step 808).

In accordance with a sixth embodiment, along with different DCI formats (e.g., a DCI format for a separate PDCCH mode with component carrier indication, a DCI format for a separate PDCCH mode without component carrier indication, and a DCI format for a joint PDCCH mode), a PDCCH mode duration indicator may be used to indicate the PDCCH mode switching. The fifth embodiment allows real-time dynamic switching, but the decoding complexity may be high because of the blind detection in every subframe. In order to reduce the blind detection complexity, the duration indicator may be used in conjunction with the blind format detection based on the DCI formats.

The duration indicator may be used to indicate how long the PDCCH mode will last when the PDCCH mode is indicated through the DCI format. The duration may be configured by RRC signaling, predetermined, or carried by the PDCCH, etc. The duration for the separate PDCCH mode and the joint PDCCH mode may be different. The duration may be defined in terms of subframes, or any other time units.

If a joint PDCCH mode DCI format is used, the PDCCH mode is switched to, or maintained at, the joint PDCCH mode, and remains for the duration (e.g., X subframes), and if a separate PDCCH DCI format is used, (e.g., either a separate PDCCH mode with component carrier indication, or a separate PDCCH mode without component carrier indication), the PDCCH mode is switched to, or maintained at, the separate PDCCH mode, and remains for the duration (e.g., X subframes). X may be any values.

In accordance with a seventh embodiment, different WTRU-specific search spaces may be defined for the PDCCH modes. For example, two or more different WTRU-specific search spaces may be used by the WTRU: a search space for a separate PDCCH mode with component carrier indication, a search space for a separate PDCCH mode without component carrier indication, and/or a search space for a joint PDCCH mode. If in a separate PDCCH mode with component carrier indication, the WTRU searches PDCCH candidates in a search space for the separate PDCCH mode with component carrier indication, if in a separate PDCCH mode without component carrier indication, the WTRU searches PDCCH candidates in a search space for the separate PDCCH mode without component carrier indication, and in a joint PDCCH mode, the WTRU searches PDCCH candidates in a search space for the joint PDCCH mode.

The WTRU-specific search spaces may be optimized in terms of size and control channel element (CCE) aggregation level supported. For example, the joint PDCCH mode WTRU-specific search space may support a CCE aggregation level of {4, 8, 16} while the separate PDCCH mode WTRU-specific search space, (e.g., either a separate PDCCH mode with component carrier indication, or a separate PDCCH mode without component carrier indication), may support a CCE aggregation level of {1, 2, 4, 8}. The separate PDCCH mode WTRU-specific search space and the joint PDCCH mode WTRU-specific search space may overlap or it may be required that the two search spaces may partially overlap depending on the switching method used in combination.

For example, in the fifth embodiment, where DCI formats associated with both joint and separate PDCCH modes are searched in a specific mode, the two search space may overlap without impact on the performance. For embodiments where the switching mode is explicitly signaled such as the ninth embodiment with MAC control element (CE) command or the tenth embodiment, blind detection processing may be reduced by ensuring that the two search spaces do not overlap or overlap partially based on the aggregation level.

The definition of the separate PDCCH mode WTRU-specific search space may be based on LTE R8 rules or may be modified to reduce blind detection operation. For example, the joint PDCCH mode WTRU-specific search space may be defined based on the separate PDCCH mode WTRU-specific search space with a control channel element (CCE) offset (which may be null) which may ensure that partial overlap based on the CCE aggregation level is used. Alternatively, the joint PDCCH mode WTRU-specific search space may be defined based on a new RNTI type (J-C-RNTI) instead of the C-RNTI. For component carriers which do not contain PDCCH candidates in joint PDCCH mode, the joint PDCCH mode WTRU-specific search space may be null. Alternatively, an RRC message may contain re-definition of the search spaces as described in the tenth embodiment below.

In accordance with an eighth embodiment, the PDCCH mode may be switched based on traffic-related triggers, such as the size of the transport block (TB), the cumulative bits received in the last predetermined number of subframes, the sum of all the TBs received in a given subframe, etc. For example, if the WTRU receives a TB larger than certain number of bits while in a first PDCCH mode, (e.g., one of a separate PDCCH mode with component carrier indication, a separate PDCCH mode without component carrier indication, or a joint PDCCH mode), the WTRU switches to the second PDCCH mode, (e.g., another one of a separate PDCCH mode with component carrier indication, a separate PDCCH mode without component carrier indication, or a joint PDCCH mode). If the WTRU receives a TB smaller than a threshold, the WTRU in a second PDCCH mode switches to the first PDCCH mode. The separate PDCCH mode, (e.g., either a separate PDCCH mode with component carrier indication, or a separate PDCCH mode without component carrier indication), may be used if a data rate is below a certain threshold.

An RRC message (e.g., RRC_Connection_Reconfiguration) may contain a specific information element (IE) (hereafter “Traffic_Switching_Threshold” IE) which defines a certain threshold (Threshold A), which once met, the WTRU switches from the first PDCCH mode to the second PDCCH mode, or vice versa. The Traffic_Switching_Threshold IE may include another threshold (Threshold B) which once met, the WTRU switches from the second PDCCH mode to the first PDCCH mode, or vice versa.

Alternatively, implicit switching may occur based on discontinuous reception (DRX)-related timers or state. A DRX is configured for the WTRU so that the WTRU periodically wakes up from an inactive state to receive and process a downlink transmission. For example, the initial subframe of on-duration (i.e., active period) may be in a first PDCCH mode, (e.g., one of a separate PDCCH mode with component carrier indication, a separate PDCCH mode without component carrier indication, or a joint PDCCH mode), and based on some activity threshold as described above or related specifically to DRX timers, the PDCCH mode may be switched to the second PDCCH mode, (e.g., another one of a separate PDCCH mode with component carrier indication, a separate PDCCH mode without component carrier indication, or a joint PDCCH mode). The PDCCH mode switching may be implicitly indicated through, for example, inactivity timers or cumulative bits received lower than a certain threshold in the last predetermined number of subframes.

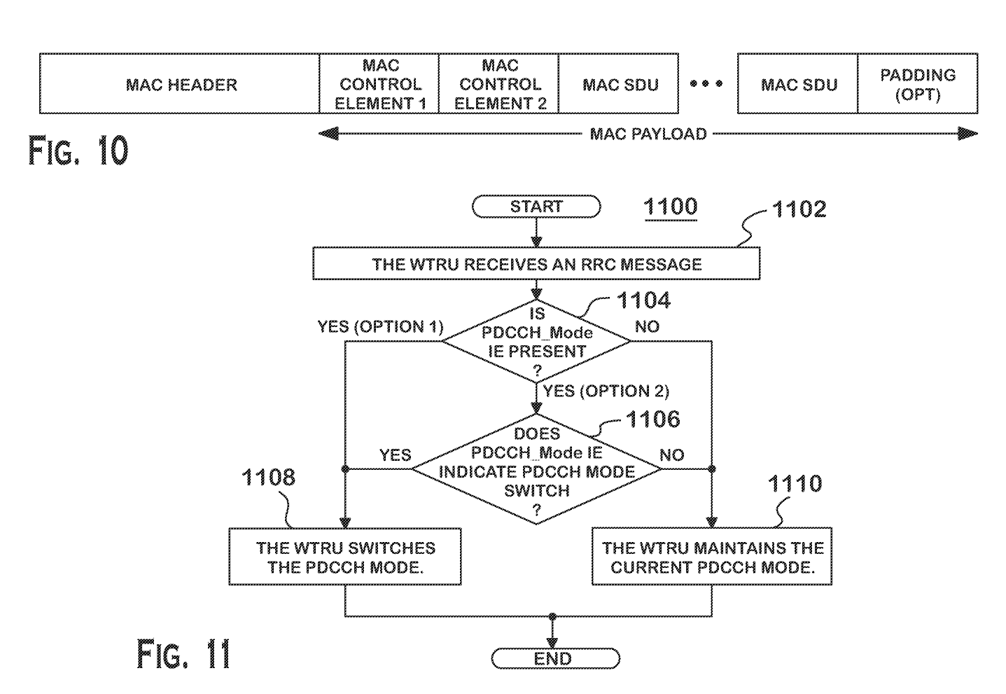

FIG. 9 is a flow diagram of a process 900 for PDCCH mode switching in accordance with the eighth embodiment. The WTRU receives an RRC message, RRC_Connection_Reconfiguration, including Traffic_Switching_Threshold IE (step 902). The RRC layer of the WTRU may send the traffic thresholds to the lower layers including threshold A, threshold B, or both (step 904). The threshold A and threshold B values may be the same or different. At every subframe, the WTRU determines whether the threshold A and/or B are met (step 906). If the WTRU in a first PDCCH mode, (e.g., one of a separate PDCCH mode with component carrier indication, a separate PDCCH mode without component carrier indication, or a joint PDCCH mode) determines that the traffic threshold A is met, the WTRU switches the PDCCH mode to the second PDCCH mode, (e.g., another one of a separate PDCCH mode with component carrier indication, a separate PDCCH mode without component carrier indication, or a joint PDCCH mode), in the next or following subframe (step 908). If the WTRU in a second PDCCH mode determines that the traffic threshold B is met, the WTRU switches the PDCCH mode to the first PDCCH mode in the next or following subframe (step 910).

In accordance with a ninth embodiment, a medium access control (MAC) control element (CE) may be used to indicate the PDCCH mode switching. FIG. 10 shows an example MAC PDU comprising a MAC header, MAC control elements, MAC service data units (SDUs), and padding. The MAC CE may be used to indicate the PDCCH mode switching. The length of the field may be one bit or multiple bits.

In any embodiments disclosed herein, a timer may be used to delay the PDCCH mode switching by a predetermined period (e.g., K subframes, or any other time unit) after receiving or detecting the PDCCH mode switching trigger (implicit or explicit trigger). For example, in accordance with the first embodiment, if the CRC check passes with the special C-RNTI while in the first PDCCH mode, (e.g., a separate PDCCH mode with component carrier indication, a separate PDCCH mode without component carrier indication, or a joint PDCCH mode), the timer is set and the PDCCH mode is switched when the timer expires. On the other hand, if the CRC check passes with the C-RNTI while in the second PDCCH mode, (e.g., a separate PDCCH mode with component carrier indication, a separate PDCCH mode without component carrier indication, or a joint PDCCH mode), the timer is set and the PDCCH mode is switched when the timer expires. Other types of triggers in accordance with other embodiments may also be applied.

This delay may be useful to optimize power consumption. Monitoring in a joint PDCCH mode or a separate PDCCH mode with component carrier indication may be performed on a single component carrier while monitoring in a separate PDCCH mode without component carrier indication may be required to be performed over multiple component carriers. Thus, the transition from the joint PDCCH mode to the separate PDCCH mode without carrier indication, or between the separate PDCCH mode with carrier indication and the separate PDCCH mode without carrier indication may require some time for the WTRU to power up the receiver components associated with the additional component carriers and complete synchronization task. The delay is to provide some time for the receiver component power up and synchronization. The delay value may be preconfigured, signaled by the network by RRC message, or variable based on the WTRU wake up capability, which may be signaled to the network.

In accordance with a tenth embodiment, higher layer signaling (e.g., RRC message) may be used to indicate the PDCCH mode switching. The network may send an RRC message, (e.g., RRC_Connection_Reconfiguration message), to the WTRU including a specific IE (referred hereafter as “PDCCH_Mode” IE) for indicating the PDCCH mode switch. For example, the presence of the PDCCH_Mode IE in the RRC message may be the trigger to switch PDCCH mode (option 1). In this case, a WTRU operating in a first PDCCH mode, (e.g., one of a separate PDCCH mode with component carrier indication, a separate PDCCH mode without component carrier indication, or a joint PDCCH mode), may start operating in a second PDCCH mode, (e.g., another one of a separate PDCCH mode with component carrier indication, a separate PDCCH mode without component carrier indication, or a joint PDCCH mode), and a WTRU in a second PDCCH mode may start operating in a first PDCCH mode once the RRC message with the PDCCH_Mode IE is received. The absence of the PDCCH_Mode IE in the RRC message may be interpreted as signifying that the current PDCCH mode is maintained. Alternatively, the PDCCH_Mode IE may specifically indicate the PDCCH mode to be used (option 2).

The PDCCH_Mode IE may contain the following (or a subset of the following): the PDCCH mode to be used (in option 2), a bitmap of component carriers indicating which component carriers the change applies, information on search space to define the search space to be used based on the new PDCCH mode, or system frame number (SFN) activation time (a global SFN activation time or a specific activation SFN), etc.

The RRC message (e.g., RRC_Connection_Reconfiguration message) may contain a specific IE, (e.g., mobilityControlInformation IE), with a target cell identity set to the current serving cell. The WTRU may initiate an intra-cell handover which effectively realizes a synchronized reconfiguration without the need of an activation time.

FIG. 11 is a flow diagram of a process 1100 of PDCCH mode switching in accordance with the tenth embodiment. A WTRU receives at the RRC layer the RRC message, (e.g., RRC_Connection_Reconfiguration message) (step 1102). The WTRU determines whether the specific IE, (e.g., PDCCH_Mode IE), is present in the RRC message (step 1104)

In option 1, if the PDCCH_Mode IE is present, the WTRU switches the PDCCH mode (step 1108). If the PDCCH_Mode IE is not present, the current PDCCH mode is maintained (step 1110). In option 2, if the PDCCH_Mode IE is present, the WTRU determines if the value of the PDCCH_Mode IE represents a change from the current PDCCH mode (step 1106). If so, the WTRU switches the PDCCH mode (step 1108). Otherwise, the current PDCCH mode is maintained (step 1110).

If the PDCCH mode change is required and if the PDCCH-Mode IE includes the SFN value, it is forwarded to the lower layers so that the PDCCH mode switching occurs at the specified SFN. Optionally, if an intra-cell handover is required, the WTRU may reconfigure the lower layers upon PDCCH mode switching to the serving cell.

In accordance with an eleventh embodiment, the WTRU may receive the RRC message to trigger PDCCH mode switching which may be applied on a component carrier, or a group of component carriers, basis. The WTRU may receive the RRC message that may configure multiple component carriers simultaneously. For example, the WTRU may receive the RRC message, (e.g., RRC_Connection_Reconfiguration message), that may include a group of IEs (referred hereafter as Component_PDCCH_Mode IEs) for a set of component carriers to trigger the PDCCH mode switching for a specific one of the component carriers, or a group of component carriers, respectively. The presence of the specific Component_PDCCH_Mode IE may trigger a PDCCH mode switching for the corresponding component carrier or component carrier group (in option 1). Alternatively, the WTRU may check the Component_PDCCH_Mode IE that may specify the PDCCH mode for the corresponding component carrier or the component carrier group (in option 2).

With this embodiment, a subset of component carriers may be configured with a first PDCCH mode, (e.g., a separate PDCCH mode with component carrier indication, a separate PDCCH mode without component carrier indication, or a joint PDCCH mode), while another subset may be configured with a second PDCCH mode, (e.g., a separate PDCCH mode with component carrier indication, a separate PDCCH mode without component carrier indication, or a joint PDCCH mode). For example, all (or a subset of) uplink carriers may be configured with one of a separate PDCCH mode with component carrier indication, a separate PDCCH mode without component carrier indication, or a joint PDCCH mode, while all (or a subset of) downlink carriers may be configured with another one of a separate PDCCH mode with component carrier indication, a separate PDCCH mode without component carrier indication, or a joint PDCCH mode.

The PDCCH_Mode IE may include the following (or a subset of the following): the PDCCH mode to be used in option 2, (e.g., a separate PDCCH mode with component carrier indication, a separate PDCCH mode without component carrier indication, or a joint PDCCH mode), information on search space to define the search space to be used based on the new PDCCH mode (the absence of this field may signify that no WTRU-specific search space is defined for that particular component carrier), SFN activation time (a global activation time or a specific activation time), and association with other carriers to define the group to which the joint PDCCH mode is applied.

The RRC message (e.g., RRC_Connection_Reconfiguration message) may contain a specific IE, (e.g., mobilityControlInformation IE), with a target cell identity set to the current serving cell. The WTRU may initiate an intra-cell handover which effectively realizes a synchronized reconfiguration without the need of an activation time.

In accordance with a twelfth embodiment, an RRC message (e.g., RRC_Connection_Reconfiguration) may be used to assign a WTRU with a WTRU identity such as a special RNTI that may be used for downlink resource allocation and uplink resource grant in a particular PDCCH mode (e.g., J-C-RNTI for a joint PDCCH mode or other type of C-RNTI for one or all of separate PDCCH modes). A special C-RNTI_Config IE (e.g., “J-C-RNTI_Config” IE for J-C-RNTI) in the RRC message may contain the particular C-RNTI assigned to the WTRU, as well as other information necessary for the PDCCH mode operation.

The special C-RNTI_Config IE may contain the following (or a subset of the following): the special C-RNTI, information that may be used to generate the PDCCH mode WTRU-specific search space (e.g., specifically which carrier the search space is located), information about the component carrier groups which supports the PDCCH mode, or the like. Each component carrier group may be assigned a different search space that may be used to trigger the PDCCH mode switching.

The presence of the special C-RNTI_Config IE in the RRC message may indicate to the WTRU that a particular PDCCH mode is configured. The WTRU may be assigned a C-RNTI on a component carrier basis as well as a different special C-RNTI per component carrier groups. In other words, the C-RNTI and the special C-RNTI may be allocated on different component carriers. This applies to uplink and downlink since the pairing between uplink and downlink may be different in carrier aggregation especially in the context of asymmetric uplink and downlink deployment. This embodiment may also be applied for different PDCCH modes, (e.g., a separate PDCCH mode with component carrier indication, or a separate PDCCH mode without component carrier indication, or a joint PDCCH mode).

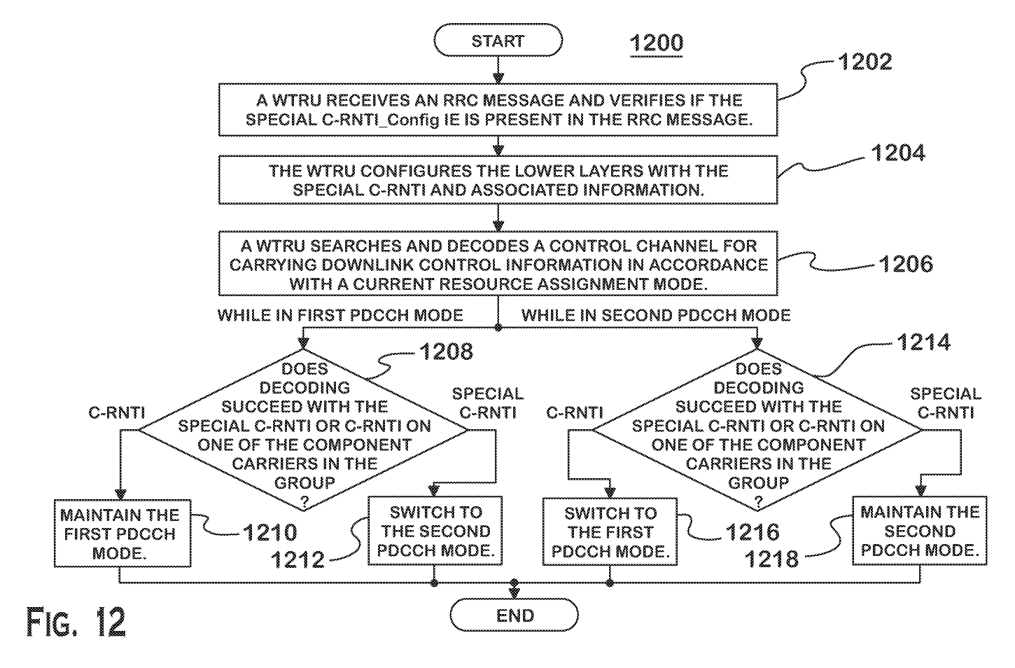

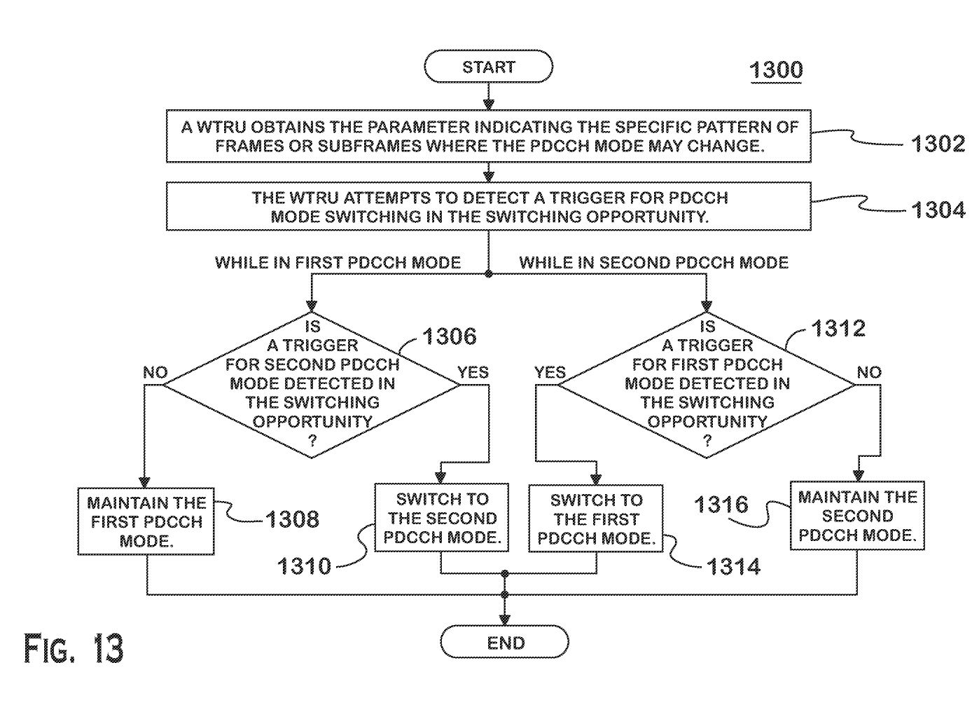

FIG. 12 is a flow diagram of a process 1200 of PDCCH mode switching in accordance with the twelfth embodiment. A WTRU receives an RRC message (e.g., RRC_Connection_Reconfiguration) and verifies if the special C-RNTI_Config IE is present in the RRC message (step 1202). If the special C-RNTI_Config IE is present, the WTRU (RRC layer) configures the lower layers with the special C-RNTI and associated information, such as a WTRU-specific search space for a specific component carrier and a component carrier group(s) (step 1204). One or several groups of component carriers may be defined in the downlink and/or uplink as configurable to any of the PDCCH modes. At initialization, the groups of component carriers may be operating in any configurable PDCCH mode, and the component carrier group may switch to another PDCCH mode once the PDCCH mode switch indicator is detected via one of the component carriers in the group.

A WTRU searches and decodes a control channel for carrying downlink control information in accordance with a current resource assignment mode (step 1206). The current resource assignment, (e.g., a separate PDCCH mode with component carrier indication, a separate PDCCH mode without component carrier indication, or a joint PDCCH mode), mode may be an initially configured mode by a higher layer (e.g., RRC signaling), a default mode, or an indicated mode. While in the first PDCCH mode, if the WTRU successfully decodes the PDCCH on one of the component carriers in the group with the special C-RNTI (step 1208), the WTRU switches to the second PDCCH mode for the group of carriers (step 1212), and if the WTRU successfully decodes the PDCCH with the C-RNTI (step 1208), the WTRU maintains the first PDCCH mode (step 1210). On the other hand, while in the second PDCCH mode, if the WTRU successfully decodes the PDCCH with the special C-RNTI on one of the component carriers in the group (step 1214), the WTRU maintains the second PDCCH mode (step 1218), and if the WTRU successfully decodes the PDCCH with the C-RNTI (step 1214), the WTRU switches to the first PDCCH mode (step 1216).

In accordance with a thirteenth embodiment, the assignment mode may be a function of the number of currently active component carriers (more generally a function of the subset of currently active component carriers). For instance, since the blind detection complexity increases with the number of carriers in the separate PDCCH mode without component carrier indication, the separate PDCCH mode without component carrier indication may be used when the number of active components carriers is below a certain threshold, whereas at or above this threshold the joint PDCCH mode or the separate PDCCH mode with carrier indication may be used.

In accordance with a first option, the set of active carriers that the WTRU is supposed to listen to may be determined independently from the PDCCH mode (joint or separate). For instance, carriers may be de-activated implicitly after a period of inactivity or explicitly through physical layer, MAC layer, or RRC signaling. Carriers may be activated through signaling at different layers.

At the beginning of every sub-frame, the WTRU knows the subset of carriers from which the WTRU may receive data. The WTRU also knows the mapping between every subset of active carriers and a PDCCH mode. Such a mapping may be signaled by higher layers or pre-determined. For example, the mapping may be defined such that a joint PDCCH mode or a separate PDCCH mode with component carrier indication is used if the number of active carriers is equal to or greater than a threshold, and a separate PDCCH mode without component carrier indication is used if the number of active carriers is lower than the threshold. Alternatively, the mapping may be defined in terms of subset of carriers within which joint PDCCH mode or separate PDCCH mode with component carrier indication may be used. For instance, assuming group A includes carriers (f1, f2, f3) and group B includes carriers (f4, f5), a joint PDCCH mode or separate PDCCH mode with component carrier indication may be used within group A and within group B, but not between carriers that belong to different groups.

When a joint PDCCH mode or a separate PDCCH mode with component carrier indication is used within a subset of carriers, it is necessary to determine which carrier(s) the WTRU is supposed to attempt PDCCH decoding from within the subset of carriers. A PDCCH priority may be defined between the subset of component carriers, and the WTRU may attempt decoding the PDCCH on the carrier that has the highest priority among the active carriers within the subset. The priority assignment of each carrier may be pre-determined or signaled by a higher layer. Alternatively, the WTRU may attempt decoding the PDCCH on one or a plurality of pre-determined or pre-signaled carrier(s) of the subset, even if the carrier(s) is inactive. When all carriers of a group are de-activated, no PDCCH decoding is necessary for this group. However, the WTRU may decode PDCCH for another group of carriers which are not all de-activated.

The DCI formats against which the WTRU attempts blind decoding for a given PDCCH may also be a function of the number of active carriers within a subset of carriers within which the joint PDCCH mode or separate PDCCH mode with component carrier indication is used. For instance, if there is a single active carrier within a subset, the WTRU may attempt blind decoding against the DCI formats defined in the 3GPP Release 8. If there are two or more active carriers within the subset, the WTRU may attempt blind decoding against DCI formats defined to support a joint PDCCH mode or separate PDCCH mode with component carrier indication, excluding the separate PDCCH mode without component carrier indication. Alternatively, the DCI formats against which the WTRU attempts blind decoding for a given PDCCH may be fixed regardless of the number of active carriers within the subset. In case where there are fewer active carriers than the number of addressable carriers with the (fixed) DCI format, the structure of the DCI format may account for the possibility that some carriers are not used.

In accordance with a second option, it may not be assumed (i.e., not necessary) that carriers may be activated or de-activated over an extended duration, and in every sub-frame data may be transmitted on a subset or all carriers and the carriers over which the data is transmitted may change on a sub-frame basis, and the PDCCH mode (joint of separate) at a given sub-frame may be a function of the set of carriers which are transmitting data at this sub-frame. The network may use joint PDCCH mode for certain subset(s) of carriers transmitting data, and any type of separate PDCCH mode for other subset(s) of carriers in a manner similar to the embodiments disclosed above. The difference with the first option is that at the beginning of every sub-frame the WTRU does not know the subset of carriers that are transmitting data. Thus, it is necessary to provide a method to allow the WTRU to decode the data without having to perform an excessive number of blind decoding attempts.

To help the WTRU determine the subset of carriers which are transmitting data, restrictions may be defined in terms of the possible subsets of carriers compared to the total number of subsets of carriers. For example, assuming that the WTRU is configured to receive data on carriers f1, f2, f3 and f4, the subsets of carriers may be limited to the following: subset A=(f1, f2, f3, f4), subset B=(f1, f2, f3), subset C=(f3, f4), subset D=(f1), and subset E=(f2). It should be understood that this is an example and other possible subsets may be defined. Alternatively, a priority may be associated to each carrier such that the carriers contained in a subset may be determined by the number of carriers that need to be in the subset. For example, carriers f1, f2, f3 and f4 may be assigned priorities 4, 2, 1, and 3, respectively, and the subsets may be implicitly defined as follows: A=(f1, f2, f3, f4), B=(f1, f2, f4), C=(f1, f4), and D=(f1).

Additionally, a PDCCH mode may be assigned for each possible subset of carriers. To restrict the number of blind decoding attempts, a joint PDCCH mode or a separate PDCCH mode with component carrier indication may be assigned to large subsets and a separate PDCCH mode without component carrier indication may be assigned to smaller subsets. In the above example, subsets A and B may be defined to use a joint PDCCH mode or a separate PDCCH mode with component carrier indication, and subsets C and D may be defined to use a separate PDCCH mode without component carrier indication. The mapping between a subset of carriers and a PDCCH mode may be pre-defined (e.g., based on the number of carriers in the subset such that the joint PDCCH mode or the separate PDCCH mode with component carrier indication may be used if the number of carriers of the subset exceeds a threshold), or signaled by a higher layer. For mapping using a joint PDCCH mode or a separate PDCCH mode with component carrier indication, rules may be defined to enable the WTRU to determine which carrier(s) the WTRU is supposed to attempt PDCCH decoding from within the subset of carriers, (e.g., based on priority of component carriers or pre-configured order, etc.).

The WTRU may first attempt decoding for the largest subset of carriers, over which a joint PDCCH mode or a separate PDCCH mode with component carrier indication is used. If a DCI codeword is decoded for this subset of carriers, the WTRU may proceed with the decoding of the data pointed to by the decoded DCI codeword and the procedure is complete for this sub-frame (unless the network is allowed to transmit data over multiple subsets of carriers). If a DCI codeword cannot be decoded, the WTRU may proceed with, for example, the next largest subset of carriers, and so on. At some point the WTRU attempts decoding for subset of carriers for which a separate PDCCH mode without component carrier indication is defined. It should be understood that the order of the subsets for which the WTRU attempts to decode DCI codewords may be different.

In accordance with a fourteenth embodiment, the combination of higher layer signaling (e.g., the tenth to thirteenth embodiments) and L1/2 control signaling (e.g., first to ninth embodiments) may be used to indicate the PDCCH mode switching. Higher layer signaling may be used to support semi-static PDCCH mode switch and L1/2 control signaling may be used to support dynamic PDCCH mode switch. Higher layer signaling may be used to reset the PDCCH mode, if necessary. For example, RRC signaling may be used to indicate or reset the PDCCH mode either periodically or aperiodically. RRC signaling may also be used to indicate if dynamic switch of PDCCH mode (e.g., using L1/2 control signaling) is enabled or not. If dynamic switch of PDCCH mode is desired, it may be enabled between RRC resets. The combination of higher layer signaling and L1/2 control signaling to indicate PDCCH mode or mode switch achieves the most flexibility and trade-off and supports both semi-static and dynamic switching for PDCCH modes.

In an asymmetric carrier aggregation case, there may be many combinations of UL/DL component carrier configuration for each WTRU, depending on traffic characteristics in DL and UL, respectively. For example, {3 DL carriers and 1 UL carrier}, {5 DL carriers and 2 UL carriers}, {1 DL carrier and 2 UL carriers}, etc. In this case, the PDCCH mode selection may be made for DAM and UAM, respectively, as described above.

In accordance with a fifteenth embodiment, the PDCCH mode may be determined depending on DCI format, (which is either DAM or UAM), used for the corresponding PDCCH transmission. For instance, since LTE DCI format 3/3A is dedicated for transmit power control (TPC) command signaling, where the TPC message may be directed to a group of WTRUs using an RNTI that is specific for that WTRU group, either separate PDCCH mode with or without component carrier indication or joint PDCCH mode may be used for the DCI format 3/3A or any other DCI formats defined for LTE-A that have similar characteristics. Separate resource assignment without component carrier indication may be used for DCI formats 0/1A and 1C in common search space. Separate resource assignment with component carrier indication may be used for DCI formats 0/1A, 1B, 1D, 2, 2A, etc. for WTRU-specific search space. The PDCCH mode in use may be predetermined or fixed and therefore is known at the WTRU. Accordingly, for some DCI format(s), the PDCCH mode is fixed thus WTRU does not need to be indicated the PDCCH mode or mode switch. For example, DCI formats 0/1A and 1C in common search space may use a resource assignment mode that uses separate resource assignment without component carrier indication. However, for other DCI formats like DCI format 0/1/2, the PDCCH mode or mode switch may be indicated. For example, DCI formats 0/1A, 1B, 1D, 2, 2A in WTRU-specific search space may use one of the two resource assignment modes with or without component carrier indication. In general, different PDCCH modes may be used and indicated for different DCI formats. For example, one PDCCH mode may be indicated for DCI format 3/3A and another PDCCH mode may be indicated for other DCI formats, and so on.

Since at each sub-frame a WTRU needs to detect if a PDCCH is for its semi-persistent scheduling C-RNTI (SPS-C-RNTI) or temporary C-RNTI in addition to its C-RNTI, all aforementioned embodiments which use a C-RNTI may be extended to an SPS-C-RNTI and a temporary C-RNTI. For example, if a WTRU attempts to decode the PDCCH with C-RNTI, temp C-RNTI, SPS-C-RNTI and their corresponding special RNTI (e.g., J-C-RNTI, J-temp-C-RNTI, J-SPS-C-RNTI). If the WTRU successfully decodes the PDCCH with the special C-RNTI, the PDCCH mode may be switched, or maintained, to the joint PDCCH mode, and if the WTRU successfully decodes the PDCCH with the normal C-RNTI, the PDCCH mode may be switched, or maintained, to the separate PDCCH mode with or without component carrier indication.

When a WTRU get its RRC connection (or RRC reconfiguration), a special C-RNTI may be configured by the network in addition to its C-RNTI. When a WTRU is configured for SPS, a special SPS-C-RNTI may be configured by the network in addition to its SPS-C-RNTI. When a WTRU is configured a temporary C-RNTI, a special temporary C-RNTI may be configured for the WTRU.

As stated above, these special RNTIs may be used for the purpose of PDCCH mode switching. The space of RNTIs for data transmission and power control (i.e., RNTIs excluding random access RNTIs (RA-RNTIs), paging RNTIs (P-RNTIs), system information RNTIs (SI-RNTIs) and those reserved for future uses) may be increased in order to accommodate the increase caused by the special RNTIs. An example of configured RNTI values is shown in table 2 below. The range of [(Value1_{FDD}+1)˜Value2] may be larger than the conventional range of [000A-FFF2] to accommodate the use of more RNTIs including regular RNTIs and special RNTIs.

TABLE 2

| Value | | |
|---|---|---|
| FDD | TDD | RNTI |
| 0 − Value1_{FDD} | 0 − Value1_{TDD} | RA-RNTI |
| Value1_{FDD} + | Value1_{TDD} + | C-RNTI, special C-RNTI, |
| 1 Value2 | 1 − Value2 | SPS C-RNTI, special SPS-C-RNTI, |
| | | Temporary C-RNTI, |
| | | special temporary C-RNTI, |
| | | TPC-PUCCH-RNTI and |
| | | TPC-PUSCH-RNTI |

| | |
|---|---|
| Value2 + 1 − Value3 | Reserved for future use |
| Value3 + 1 | P-RNTI |
| Value3 + 2 | SI-RNTI |

In accordance with a sixteenth embodiment, an explicit indication may be used to indicate the PDCCH mode on a cell specific basis to reduce the overhead associated with managing the switching of modes on a per WTRU basis and reducing the complexity associated with blind detection. Cells supporting multiple PDCCH modes may broadcast the parameters describing the possible PDCCH modes to WTRUs that support multiple PDCCH modes. For example, extended system information, readable by the WTRUs supporting multiple PDCCH modes, may indicate that those WTRUs may assume that a particular PDCCH mode may be used for them. The PDCCH mode may also be time dependent. For example, the extended system information, readable by the WTRUs supporting multiple PDCCH modes, may indicate that those WTRUs may assume that PDCCH mode 1, (e.g., one of a separate PDCCH mode with component carrier indication, a separate PDCCH mode without component carrier indication, or a joint PDCCH mode), may be used in set 1 of subframes, and PDCCH mode 2, (e.g., another one of a separate PDCCH mode with component carrier indication, a separate PDCCH mode without component carrier indication, or a joint PDCCH mode), may be used in set 2 of subframes, and optionally any PDCCH mode may be used in the remaining subframes, if configured, (possibly requiring additional detection).

A WTRU acquires the system parameters from the broadcast information. If the WTRU does not support multiple PDCCH modes, the WTRU does not need to know any parameters related to PDCCH modes (it is backward compatible). If the WTRU supports multiple PDCCH modes, (i.e., LTE-A WTRU), the WTRU learns the PDCCH modes that may exist for PDCCH signals the WTRU receives.

When the LTE-A WTRU receives a PDCCH in subframes indicated as joint PDCCH mode, the LTE-A WTRU may assume the joint PDCCH mode is used, and when the LTE-A WTRU receives a PDCCH in subframes indicated as a separate PDCCH mode with or without component carrier indication, the LTE-A WTRU may assume a separate PDCCH mode is used. Alternatively, when the LTE-A WTRU receives a PDCCH in subframes indicated as separate PDCCH mode with component carrier indication, the LTE-A WTRU may assume the separate PDCCH mode with component carrier indication is used, and when the LTE-A WTRU receives a PDCCH in subframes indicated as a separate PDCCH mode without component carrier indication, the LTE-A WTRU may assume a separate PDCCH mode without component carrier indication is used, or vice versa. When the LTE-A WTRU receives a PDCCH in subframes indicated as both PDCCH modes, the LTE-A WTRU may not assume a particular PDCCH mode is used. When the LTE-A WTRU does not receive the extended system information indicating the PDCCH modes, the LTE-A WTRU may assume that a separate PDCCH mode with or without component carrier indication is used.

In accordance with a seventeenth embodiment, the PDCCH mode may be switched on specific PDCCH mode switching opportunities to reduce the decoding complexity. The PDCCH mode switching may be indicated in accordance with any one of the above embodiments. For example, different DCI formats (e.g., separate and joint formats) may be used to indicate a specific PDCCH mode, such that a DCI format of joint PDCCH mode may be used to switch to the joint PDCCH mode and a DCI format of a separate PDCCH mode may be used to switch to the separate PDCCH mode with or without component carrier indication as described in the fifth embodiment. The opportunities may be defined by a parameter indicating a specific pattern of frames or subframes where the PDCCH mode may change.

FIG. 13 is a flow diagram of a process 1300 for PDCCH mode switching in accordance with the seventeenth embodiments. A WTRU obtains the parameter indicating the specific pattern of frames or subframes where the PDCCH mode may change (step 1302). The parameter may be configured by RRC signaling, predetermined, or indicated through for example broadcasting, multicasting, or unicasting. The parameter value may be every N-th subframe, every frame with (SFN mod N)=0, or the like. The WTRU attempts to detect a trigger for PDCCH mode switching in the switching opportunity (step 1304).

If the WTRU detects a trigger for a second PDCCH mode, (e.g., one of a separate PDCCH mode with component carrier indication, a separate PDCCH mode without component carrier indication, or a joint PDCCH mode), in a switching opportunity while in a first PDCCH mode, (e.g., another one of a separate PDCCH mode with component carrier indication, a separate PDCCH mode without component carrier indication, or a joint PDCCH mode) (step 1306), the WTRU switches to the second PDCCH mode (step 1310). If the WTRU does not detect a trigger for the second PDCCH mode in a switching opportunity while in a first PDCCH mode (step 1306), the WTRU maintains the first PDCCH mode (step 1308).

If the WTRU detects a trigger for a first PDCCH mode in a switching opportunity while in a second PDCCH mode (step 1312), the WTRU switches to the first PDCCH mode (step 1314). If the WTRU does not detect a trigger for the first PDCCH mode in a switching opportunity while in the second PDCCH mode (step 1312), the WTRU maintains the second PDCCH mode (step 1316). The WTRU may assume that the DCI format in subframes that are not switching opportunities is the same DCI format used in the previous subframe where PDCCH was received.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for configuring a resource assignment mode for a plurality of component carriers, the method comprising:
a wireless transmit/receive unit (WTRU) receiving signaling indicating a resource assignment mode for a plurality of component carriers allocated for the WTRU, the WTRU having a capability of supporting multiple resource assignment modes; and
the WTRU attempting to decode a control channel for resource assignment based on the indicated resource assignment mode.

2. The method of claim 1 wherein the resource assignment mode is configured for the WTRU via higher layer signaling.

3. The method of claim 1 wherein the resource assignment mode is specific to the WTRU.

4. The method of claim 1 wherein the resource assignment mode is specific to a component carrier or a group of component carriers.

5. The method of claim 1 wherein the resource assignment mode is configured separately for a downlink component carrier and an uplink component carrier.

6. The method of claim 1 wherein the resource assignment mode includes at least one of a separate assignment mode with component carrier indication, a separate assignment mode without component carrier indication, or a joint assignment mode.

7. The method of claim 1 further comprising:
switching a resource assignment mode among the resource assignment modes based on the signaling.

8. The method of claim 7 wherein the information element indicates an activation time for the resource assignment mode switching.

9. The method of claim 7 further comprising:
receiving cell-specific information indicating a cell-specific resource assignment mode to be used in a cell, wherein the WTRU attempts to decode the control channel based on the cell-specific resource assignment mode.

10. The method of claim 7 wherein the resource assignment mode switching occurs in a specific PDCCH mode switching opportunity.

11. The method of claim 1 further comprising:
the WTRU determining a number active component carriers, wherein the WTRU configures the resource assignment mode based on the number of active component carriers.

12. The method of claim 1 wherein a priority is defined for each of the component carriers such that the WTRU attempts to decode the control channel based on the priority.

13. The method of claim 1 wherein a downlink control information (DCI) format against which the WTRU attempts to decode for the control channel is determined based on a number of active component carriers for the WTRU.

14. A wireless transmit/receive unit (WRU) configured to support a plurality of resource assignment modes for a plurality of component carriers, the WTRU comprising:
a transceiver configured to transmit and receive via multiple component carriers; and
a processor configured to receive signaling indicating a resource assignment mode for a plurality of component carriers allocated for the WTRU, and attempt to decode a downlink control channel for resource assignment based on the indicated resource assignment mode among a plurality of resource assignment modes supported by the WTRU for a plurality of component carriers.

15. The WTRU of claim 14 wherein the processor is configured to obtain the resource assignment mode configured for the WTRU via higher layer signaling.

16. The WTRU of claim 14 wherein the resource assignment mode is specific to the WTRU.

17. The WTRU of claim 14 wherein the resource assignment mode is specific to a component carrier or a group of component carriers.

18. The WTRU of claim 14 wherein the processor configures the resource assignment mode separately for a downlink component carrier and an uplink component carrier.

19. The WTRU of claim 14 wherein the resource assignment mode includes at least one of a separate assignment mode with component carrier indication, a separate assignment mode without component carrier indication, or a joint assignment mode.

20. The WTRU of claim 14 wherein the processor is configured to switch the resource assignment mode based on the signaling.

21. The WTRU of claim 20 wherein the processor is configured to switch the resource assignment mode at an activation time included in the signaling.

22. The WTRU of claim 20 wherein the processor is configured to receive cell-specific information indicating a cell-specific resource assignment mode to be used in a cell, and attempt to decode the control channel based on the cell-specific resource assignment mode.

23. The WTRU of claim 20 wherein the processor is configured to perform the resource assignment mode switching in a specific PDCCH mode switching opportunity.

24. The WTRU of claim 14 wherein the processor is configured to determine a number active component carriers, and configure the resource assignment mode based on the number of active component carriers.

25. The WTRU of claim 14 wherein a priority is defined for each of the component carriers and the processor is configured to attempt to decode the control channel based on the priority.

26. The WTRU of claim 14 wherein a downlink control information (DCI) format against which the processor attempts to decode for the control channel is determined based on a number of active component carriers for the WTRU.
